(19) United States
(12) Patent Application Publication
(10) Pub. No.: US 2026/0055752 A1
(43) Pub. Date: Feb. 26, 2026

(54) HIGH FLOW FUEL INJECTOR

(71) Applicant: MRB INJETORES LTDA., Curitiba (BR)

(72) Inventor: RODERJAN BUSATO, Curitiba (BR)

(21) Appl. No.: 18/815,031

(22) Filed: Aug. 26, 2024

(30) Foreign Application Priority Data
Aug. 25, 2023 (BR) 10 2023 017185 0

(51) Int. Cl. F02M 61/10; F02M 61/20

(52) U.S. Cl. CPC F02M 61/10; F02M 61/20

(57) ABSTRACT

This invention refers to a high flow fuel injector, designed and engineered to meet the needs of combustion engines in automobiles in general, especially high-performance engines that benefit from a high and stable flow of fuel at low pressures. The object of this invention patent overcomes the limitations and disadvantages existing in the state of the art, allowing high fuel flows at low pressures, through optimized geometry and construction, improved manufacturing and materials chosen and simplification of the number of components. The high flow fuel injector (1) consists of a connector housing (11), coil body (12), coil and connector assembly (13), needle (14), needle body (15) and spring (16).

### FIELD OF INVENTION

The present invention refers to a high-flow fuel injector designed for combustion engines, automobiles in general, especially high-performance engines that benefit from a high and stable fuel flow at low pressures. The advantages, which involve both the technical performance of the object and ease of maintenance, arise from the innovative mechanical construction, which reduces the number of components and optimizes them, improving the fuel flow, the efficiency and the life cycle of the injector.

### Fundamentals of the Invention

It is widely known that there are limitations in the operation of high-performance combustion engines due to the use of traditional fuel injectors, whose fuel flow is low, restricting performance—which may be suitable for popular low performance automobiles —, but prevents high performance cars from operating as desired. Furthermore, traditional injectors are unable to maintain a stable relationship between flow and injection time throughout operation, resulting in inconsistent flow and loss of efficiency, and can be difficult to maintain, precisely due to the number of internal components.

Carrying out searches in national and international patent banks to define the state of the art the following relevant prior art documents were found:

Chinese patent application CN104612875A revealed new parts corresponding to the high-flow injection nozzle of a common rail injector. The parts consist of a needle valve body, wherein the upper segment of the needle valve is oriented by the inner wall of the needle valve body; an oil inlet passage is arranged between the upper segment of the needle valve and the inner wall of the needle valve body; the lower end of the needle valve is provided with a cone-type needle valve sealing receptacle surface; the lower part of the needle valve body is provided with a conical surface of the needle valve body and a pressure chamber; the conical surface of the needle valve body is combined with the surface of the needle valve sealing receptacle; the side wall of the pressure chamber is provided with spray holes; an alpha 1 included angle formed by the surface of the needle valve sealing receptacle is smaller than an alpha 2 included angle formed by the tapered surface of the needle valve body. Chinese patent CN104612875 reveals an injector recommended for small engines, with the disadvantages of having many components and being complex in construction, making maintenance and assembly difficult. The internal channel of the injector does not vary in diameter along its length, so it does not optimize fuel flow.

Chinese patent CN113700584A describes a needle valve for a fuel injection nozzle of a large-flow common-rail fuel injector, a corresponding part of the fuel injection nozzle and a working method of the needle valve for the nozzle large-flow common-rail fuel injection injectors. The needle valve comprises a valve seat, a cavity is formed on the surface of one end of the valve seat, a threaded hole is formed at the bottom of the cavity, a guide hole is formed at the bottom of the threaded hole, a spherical hole is formed at the bottom of the threaded hole, a spray is fixedly connected to the surface of one end of the guide hole. The object of Patent CN113700584A is difficult to assemble and uses a guide rod, threaded hole and guide hole, and a spring of short length, resulting in unstable operation and loss of efficiency. Furthermore, the large number of moving components favors wear, and the internal geometry of the injector does not provide an optimized fuel flow.

The US patent U.S. Pat. No. 8,857,743B2 disclosed a fuel injection valve structure in which the needle bounce can be suppressed, and the position of the armature can be fixed while the valve is closed, without increasing the number of components and the number of processes. The object of US patent U.S. Pat. No. 88,577,432B2 uses a needle guide ring, in addition to a short spring, favoring component wear, causing the injector's performance and useful life to be reduced.

Japanese patent JP4508142B2 describes a fuel injection valve having a nozzle section with a first imaginary circle that is defined approximately coaxially to a central axis of the nozzle section and having a first arc with injection ports and a first arc without injection holes. The injection holes are arranged on the arch with regularly spaced injection holes, not on the arch without injection holes. The midpoints of the two injection holes that are arranged at both ends of the arc with the injection holes form a central angle of 70-110 degrees with respect to the center point of the imaginary circle. The object of Japanese patent JP4508142B2 is difficult to assemble, consisting of many components, including more than one magnetic component, which favors instability in the magnetic field and loss of injection efficiency.

US patent U.S. Pat. No. 10,550,811B2 disclosed a fuel valve for injecting fuel into the combustion chamber of a large two-stroke self-igniting internal combustion engine, with a valve needle that is flexibly inclined toward a valve seat. The effective pressure surface that causes fuel pressure to drive the valve needle in the opening direction increases significantly as the valve needle lifts from the valve seat. A supplementary effective pressure surface is provided on the valve needle. The object of patent U.S. Pat. No. 10,550,811B2 is made up of many components, using two springs and having an elongated length, being used in diesel combustion engines, not the Otto cycle. The plurality of components increases the need for maintenance due to wear. The existence of two springs makes the device more susceptible to instability when subjected to high pressures. These, and other factors, limit the performance of this injector.

The high flow fuel injector object of this patent was developed for overcoming the limitations and disadvantages existing in the prior art, allowing high fuel flows at low pressures, through optimized geometry and construction, improvement of manufacturing and choice of better materials and simplification of the number of components, with a single-piece needle, silver-plated connectors, longer springs, valve seat with optimized internal geometry, in addition to not requiring an elastic pin, internal lock for the seat, seat for sealing, ring to guide needle and sieve for fuel atomization. Another advantage of the patent object is the possibility of removing the injector and sending it for maintenance by the manufacturer, in addition to the low maintenance complexity, resulting from the simplification of the product, the number of components, and its manufacturing.

Prior art documents present the following technical problems that were solved by the present invention, as shown below:
Many of the devices found in the prior art present generation of noise and heating in the coil connectors due to the material used and to the lack of coating. Solved by silver plating on the connectors. The coating of electrical connectors in silver, or another noble metal, and with resin on the coils, minimizes energy losses due to heating or noise;
In several devices, the movement of the elastic pin inside the injector is observed when subjected to certain pressures, due to the internal geometry that allows its undue displacement. Solved by replacing spring pin with seat hole in coil body, allowing linear fuel flow;
The needles in existing patents are made up of two parts, with different materials, compromising the mechanical resistance and magnetism of the piece. Solved by the single-body needle, machined from a single magnetized material, allowing the needle to work consistently;
From the devices contained in the prior art, the turbulent fuel flow caused by the chamber generated at the end of the needle length. Solved by specific positioning, angle and diameter on single material needle;
In many prior art devices, the fuel flow is turbulent due to the sealing locks, whose geometry is designed solely for the purpose of locking the seal and is not designed to optimize the fuel flow. Solved by the use of locks with a funnel-shaped chamber, avoiding turbulence and optimizing flow;
Many of the devices found in the prior art present non-linear fuel flow due to the geometry of the valve seat, which positions the sealing ring in the lowest part. Solved by innovative valve seat geometry, with a needle sealing angle and a fuel outlet angle; and
Many of the devices contained in the technical report use a sieve at the fuel outlet to distribute the flow and atomize the fuel and this component, in addition to being another piece to be manufactured and suffering wear and tear resulting in the need of maintenance, it interferes with the fuel flow. Solved by fuel outlet angulation and needle geometry.

The need to achieve high fuel flow rates under low pressure, in order to improve control of the amount of fuel admitted by the engine and improve the performance of high-performance engines, led the inventor to design and build the fuel injector object of the present patent. In the case of high-flow injectors, all aspects of construction are important and can change the functioning of the injector, as well as the materials and construction methods used.

The inventor has extensive professional and personal experience with racing cars, and this led him to realize that the available injectors limit high-performance engines, preventing the cars from using all the available power. There are no high-flow injectors capable of operating at a low differential pressure. This led the inventor to begin extensive research and development work that culminated in the subject of patent application No. BR 10 2021 020813-9, entitled HIGH-FLOW FUEL DOSING VALVE. This optimized valve construction comprises an optimized single-piece injector needle, optimized valve seat, uniquely shaped chamber, uniquely shaped valve lock and optimized valve body, which provides a higher fuel injection speed, with greater precision, better control and greater efficiency in your work.

After a positive experience in the commercialization and application of the high-flow fuel metering valve object of the aforementioned patent application, which met the expectations of users of extremely high-performance automobiles and engines, including in the sphere of motorsport, mainly drag racing, which requires very high acceleration in a short space of time, the inventor came across part of the market that was helpless when it came to high-flow injectors. These are high-performance cars and engines, but not necessarily used in motorsport, including powerful cars used on urban roads, but which require special components to achieve the expected performance. For this entire range of vehicles and engines, there is no injector in the state of art capable of offering a high flow of fuel, with injection occurring in a linear and stable manner, which is what the object of this patent offers. Soon, the inventor began his work on developing a high-flow injector—between 170 lb/h and 340 lb/h, mainly-whose fuel flow occurred linearly and at low differential pressure-especially 3 bar (43.5 PSI).

As previously mentioned, the inventor was very successful in developing the fuel injector subject of patent application No. BR 10 2021 020813-9, entitled HIGH-FLOW FUEL DOSING VALVE. The invented valve allowed the optimized operation of very high-performance car engines, achieving the expected performance. This led the inventor to look for a solution for other engines, with slightly lower performance than those used in patent application No. BR 10 2021 020813-9, but still with high power and torque, which require a fuel flow of 170 lb/h, 240 lb/h and 340 lb/h, among others, at stable and relatively low pressures for such a flow, mainly 3 bar (43.5 PSI).

Initially, the inventor sought to replicate the successful results of the object of patent application no. BR 10 2021 020813-9, however, the reduction in dimensions of the valve in the cited patent application, even maintaining the appropriate proportions, proved unsatisfactory for this new range of engines that require high flow.

Another challenge was defining the material to be used. A material with high mechanical resistance and favorable to the magnetic field used was needed. It is a high impedance injector, whose resistance varies between 7 and 15Ω, which is why no operational amplifier or “peak and hold” is used. Firstly, to select the best wire for the injector coil, more than 500 practical tests were carried out with more than 10 types of wires, using resistances from 7 to 15Ω, of different inductances and magnetic field strengths. The inventor was looking for a material that could withstand the temperature it would be subjected to and was resistant to different types of existing fuels.

The needle and seat must also be manufactured from materials with specific characteristics, mainly corrosion resistance, high mechanical resistance and influence on its magnetic field. Furthermore, the geometry and angulation of the needle, seat and orifice were important variables to be defined. Initially, a spherical needle and angled seat were used and, after more than 400 tests, a satisfactory result was achieved in terms of injection performance, however the hardness of the materials and geometry led to sealing instability and leaks. We switched to another needle geometry, a face needle with seat, which solved the sealing problem, but its injection performance was insufficient, even when using different angles and holes.

So, after carefully analyzing the injector and its components, the idea of changing internal parts emerged to achieve the desired performance, and also optimize the manufacturing process. An injector without an internal sieve, seat, lock and guide ring was created. After several tests, the injector still had problems, requiring modifications, including its dimensions.

In the initial design, the injector had a spherical needle, needle body, seat, ring, lock and coil body. In the coil tests, 5 wires of different materials and diameters were used, in addition to changing the number of turns. After assembly, the injector showed low performance, reaching a flow rate of just 100 lb/h. Contraction has occurred in the coil. This led the inventor to carry out tests using VG430 steel in the coil spool, which changed the magnetic field. We switched to a nylon spool with a stainless-steel bushing, but the performance was still not satisfactory. The objective was to reach a pressure of 120 psi, but only 40 psi was achieved. Coil contraction also compromised the injector's performance. It was necessary to use another, more resistant material. After testing, AWG 33 wire was chosen as the best option for the coil.

Furthermore, different component geometries were tested. Needles with diameters of 10 mm, 8 mm and 6 mm were used in tests, but the results were not satisfactory. A “deadtime”—injector response time—of 1.0 ms was sought and the lowest obtained was 1.7 ms. Attempts were then made to reduce the mass of the needle with the aim of reducing deadtime and achieving a flow rate of 170 lb/h, without success. There were problems with the seal that resulted in leaks. By modifying the fuel outlet, using different angles, diameters and number of holes, it was possible to achieve a flow rate of 190 lb/h and a deadtime of 1.67 ms, that is, the flow rate exceeded what was desired and the performance was below expectations.

It was realized that component dimension tolerances were extremely important, directly influencing injector performance. Again, turning to the object of patent application no. BR 10 2021 020813-9 for inspiration, modifications were made resulting in the possibility of achieving a flow rate of 171 lb/h with a deadtime of 0.99 ms. After some fine adjustments the results were a flow rate of 170 lb/h with a deadtime of 0.79 ms. Thus, laboratory tests were carried out to mounting the injector on a car engine, but the sealing problems persisted. The test results are shown in Table 1:

TABLE 1
static and dynamic flow test results.

| | | STAT- | DY- | | DEAD | |
|---|---|---|---|---|---|---|
| | | IC | NAMIC | FALL | TIME | SPRING |
| MODEL | GAP | [lb/h] | [lb/h] | [%] | [ms] | LOAD |
| 1 | 19 | 99 | 97 | 0.02 | 0.90 | −13.00 |
| Sphere 2 | 19 | 103 | 99 | 0.04 | 0.92 | −13.00 |
| 45° - 3 holes B | 15 | 141 | 162 | −0.15 | 0.95 | −9.00 |
| 45° - 3 holes A | 17 | 152 | 171 | −0.13 | 0.99 | −12.00 |
| 15th - Corp | 16 | 158 | 149 | 0.06 | 0.99 | −13.00 |
| AG 2.6 A | | | | | | |
| 15th - Corp | 16 | 158 | 162 | −0.02 | 0.99 | −16.00 |
| AG 2.6 B | | | | | | |
| 25° - 2 holes B | 18 | 158 | 167 | −0.06 | | −9.00 |
| 45° - 2 holes A | 19 | 158 | 166 | −0.05 | 0.79 | −12.00 |
| 45° - 2 holes B | 21 | 160 | 171 | −0.07 | 0.73 | −9.00 |
| 25° - 2 holes A | 18 | 162 | 166 | −0.02 | 0.99 | −9.00 |
| 25° - 2 holes C | 19 | 166 | 168 | −0.01 | | −12.00 |
| 20° - 2 holes A | 19 | 168 | 152 | 0.09 | 0.90 | −9.00 |
| 20° - 2 holes B | 19 | 168 | 152 | 0.09 | 1.06 | −9.00 |
| 15th - edge C | 19 | 170 | 152 | −0.10 | 1.06 | −20.00 |

The configuration shown in the last line of Table 1 presented the best practical results.

After problems with assembly, it was realized that the injector was too large, making it impossible to fit into the fuel flute. It was necessary to readjust the dimensions of the injector, reducing its length.

The product was then remodeled and, seeking to solve the sealing problems faced, the face needle and face seat were developed, which solved the sealing problem with face seat. Furthermore, to simplify the assembly process, the injector was changed again, this time without the seat, lock and ring components.

In this way, with the simplification of components, after some adjustments, it was possible to achieve the expected results, an injector capable of reaching a flow rate of 170 lb/h with the desired performance.

### DESCRIPTION OF THE DRAWINGS

For better clarification and understanding of constructiveness, the following figures are attached:

FIG. 1 illustrates the perspective and exploded view of the high-flow fuel injector (1) and its components-connector housing (11), coil body (12), coil and connector assembly (13), needle (14), coil body needle (15) and spring (16);

FIG. 2 illustrates the front view of the high-flow injector (1) and its assembled components;

FIG. 3 illustrates the side sectional view of the high-flow injector (1) and its assembled components;

FIG. 4 illustrates the side view of the coil body (12) and its division into parts for description purposes-first coil body part (121), second coil body part (122), third coil body part (123) and fourth part of the coil body (124);

FIG. 5 illustrates the perspective view of the coil body (12);

FIG. 6 illustrates the side sectional view of the coil body (12);

FIG. 7 illustrates the side view, in section, in a plane perpendicular to that represented in FIG. 6, showing the angles α1 and α2 inside the third part of the coil body (12);

FIG. 8 illustrates the side view of the coil and connector assembly (13);

FIG. 9 illustrates the top view of the coil and connector assembly (13);

FIG. 10 illustrates the sectional side view of the coil (131);

FIG. 11 illustrates the perspective view of the back of the coil (131), highlighting the tear in the coil (1314);

FIG. 12 illustrates the perspective view of the needle (14);

FIG. 13 illustrates the sectional side view of the needle (14);

FIG. 14 illustrates the side view in a perpendicular plane of the needle (14);

FIG. 15 illustrates the side view of the needle body (15) and its division into parts for description purposes-first needle body part (151), second needle body part (152), third needle body part (153) and fourth part of the needle body (154);

FIG. 16 illustrates the side sectional view of the needle body (15);

FIG. 17 illustrates the side view of the needle body (15);

FIG. 18 illustrates the sectional perspective view of the needle body (15);

FIG. 19 illustrates the detail of the lower part of the needle (14), in its embodiment in which there is a centralized projection (148) on the lower face of the needle;

FIG. 20 illustrates the side view of the spring (16); and

FIG. 21 illustrates the top view of the spring (16).

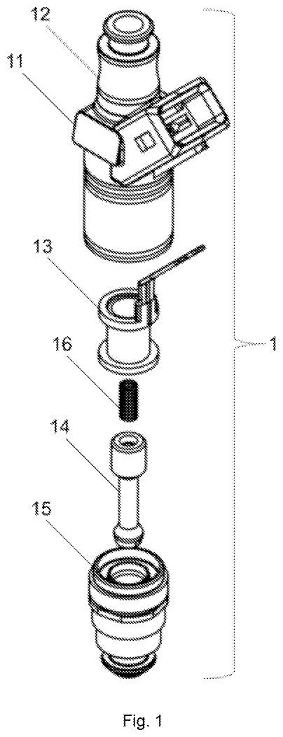

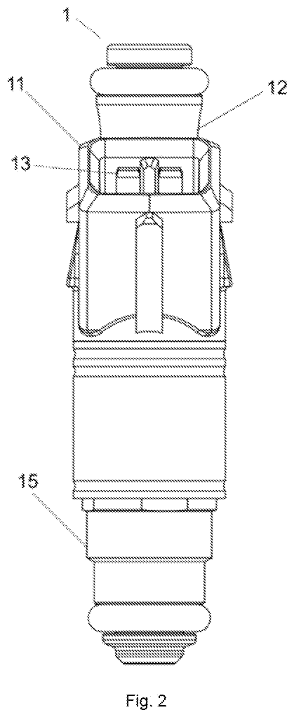

### DESCRIPTION OF THE INVENTION

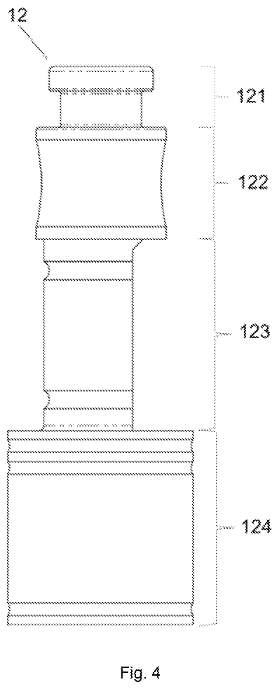

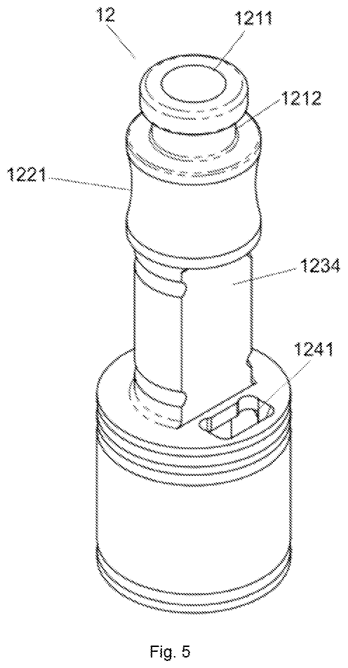

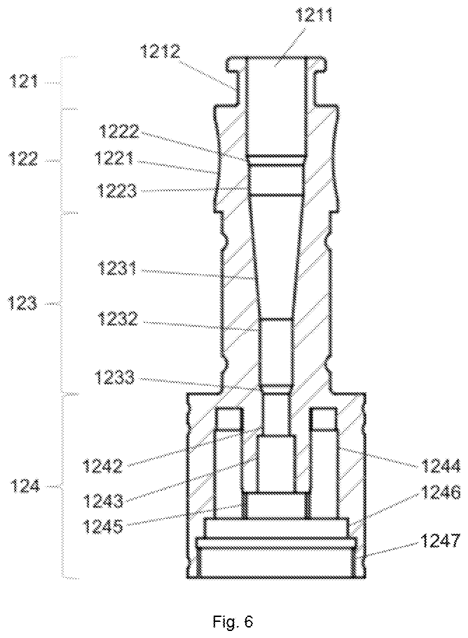

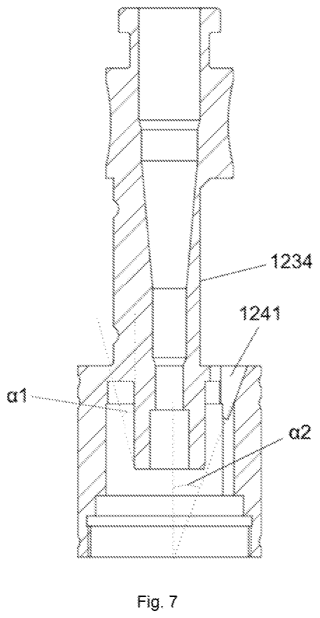

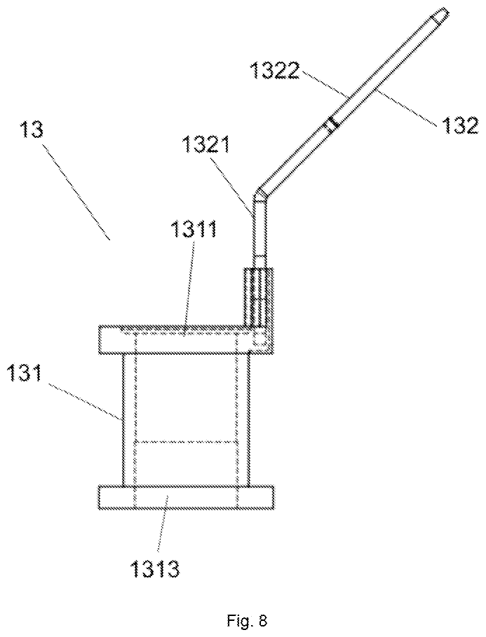

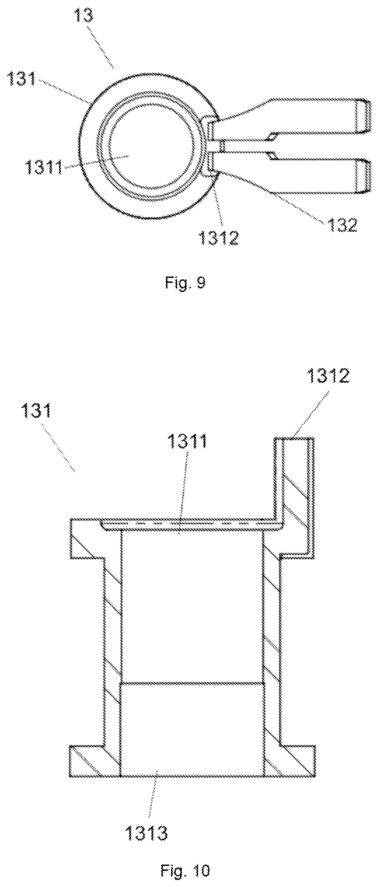

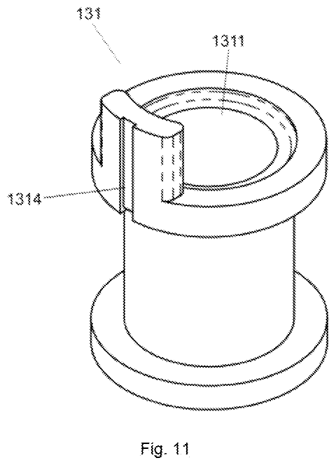

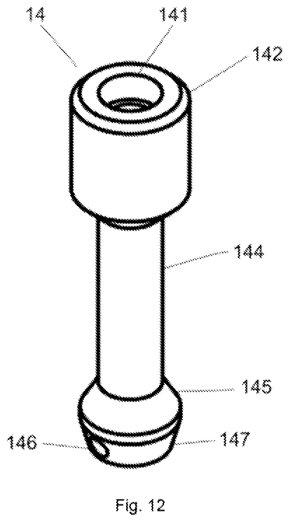

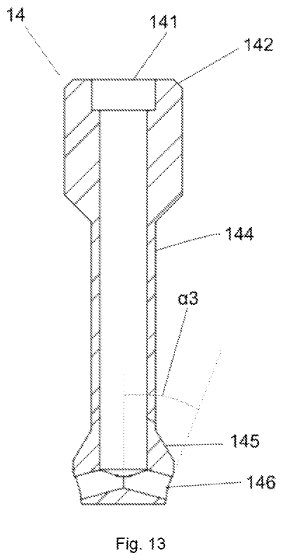

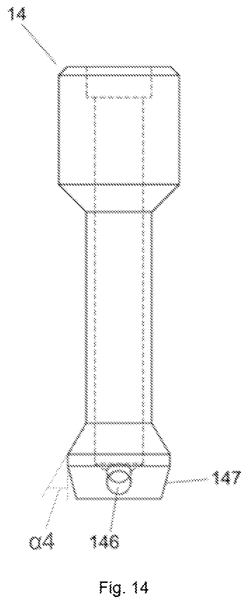

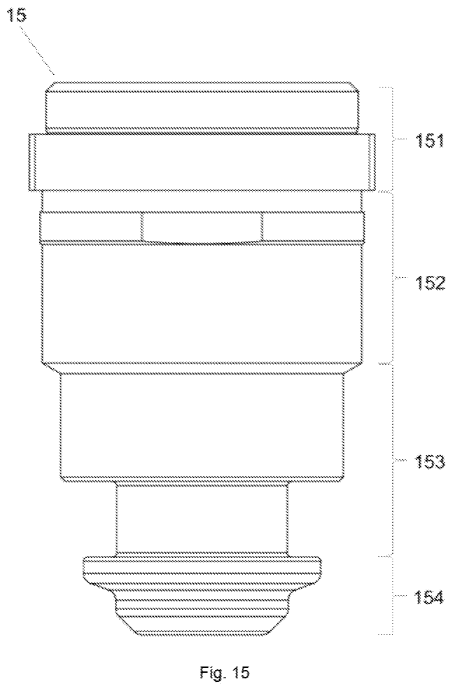

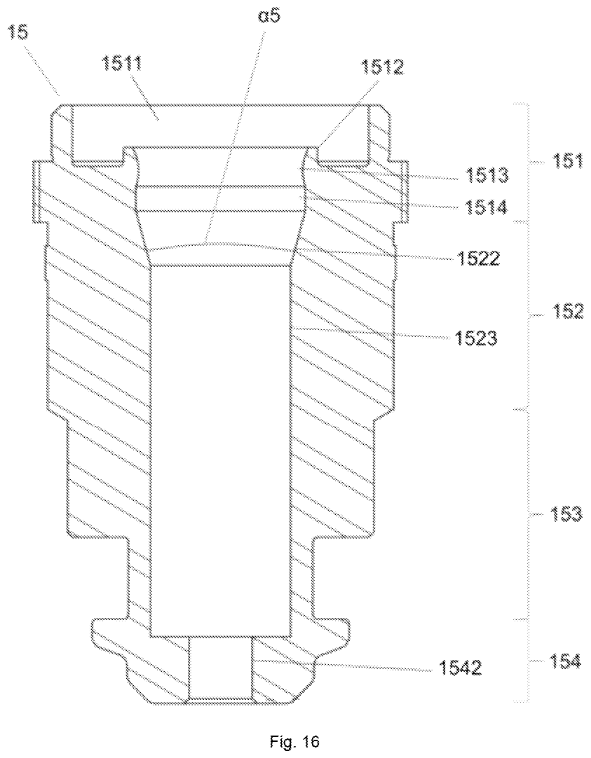

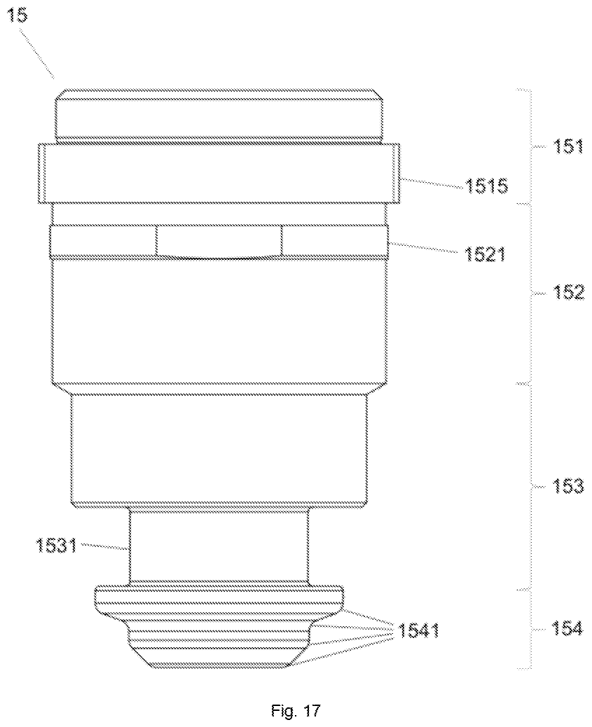

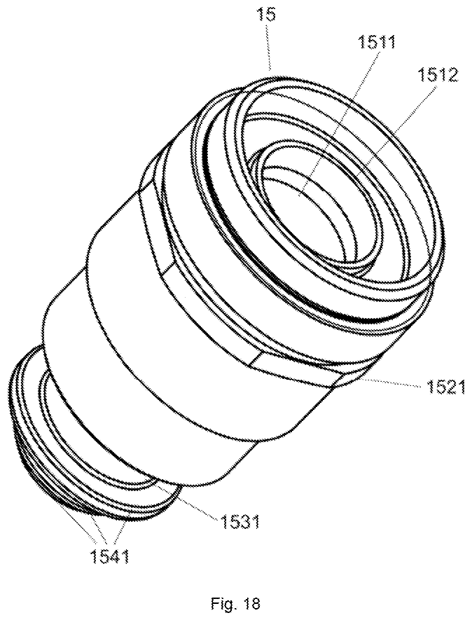

High-flow fuel injector (1) is equipped with a connector housing (11), cylindrical in shape, injected in polymeric material and contains a projection that surrounds the connector (132); coil body (12), made of metallic material, predominantly cylindrical in shape, with a stepped profile on the external part and with a through channel on the internal part, containing, for description purposes, four parts, as shown in FIGS. 4 and 6, with the first part of the coil body (121) is cylindrical and has a fuel inlet channel (1211) on its upper face and its initial external diameter is reduced, forming the recess of the coil body (1212) with rounded chamfers reducing the diameter for insertion of a sealing ring, the second part of the coil body (122) is cylindrical, has a convex side surface (1221) and an internal channel whose diameter is reduced by tapering in the internal channel A (1222), resulting in a reduced internal channel diameter A (1223), the third part of the coil body (123), shaped like an incomplete cylinder, has a flat face on the coil body (1234), in the longitudinal direction, with a chamfer on its upper part, has, in its interior, in continuation of the reduced diameter internal channel A (1223), taper in the internal channel B (1231), which connects to the reduced diameter internal channel B (1232), which in turn connects to the taper in the internal channel C (1233), and the fourth part of the coil body (124), also cylindrical in shape, has, on its upper face, on the same side that the third part of the coil body (123) has a flat face on the coil body (1234), a connector input channel (1241), with an angle inclination α2 (α2), between 15° and 25°, preferably 20°, inside it has an internal channel of reduced diameter C (1242), where the spring (16), which connects to the internal channel of reduced diameter D (1243), which, in turn, is connected to the needle fitting space (1245), also has an internal space for coil A (1244), with chamfer angle α1 (α1), between 0.5° and 2°, preferably 1.5°, internal space for the needle body (1246), and internal thread (1247); equipped with a coil and connector assembly (13), which contains coil (131) and connector (132), as detailed in FIGS. 8 and 11, the coil (131) is cylindrical in shape and has a central hole A (1311), central hole B (1313), and projection with passage of the connector (1312), which has a tear in the coil (1314), and the connector (132), made of metallic material, is formed by two rods, each one having a short part of the connector (1321) and long part of the connector (1322), with an inclination between 35° and 55°, preferably 45°; equipped with a needle (14) made of metallic material, cylindrical in shape and with a stepped profile, which contains a central hole with a recess (141) on its upper face, chamfer A (142) and chamfer B (143), on the upper and lower edges, contains central body of the needle (144), with a smaller diameter than the initial one, chamfer C (145), with angle inclination α4 (α4) and chamfer D (147) at the bottom of the central body of the needle (144), and this has the fuel outlet holes (146), in diametrically opposite positions and inclined at an angle α3 (α3) in relation to the central axis; and equipped with a needle body (15), made of metallic material, cylindrical in shape and with a stepped profile, which contains, for description purposes, four parts, as shown in FIGS. 15 to 17, the first part of the needle body (151) has, internally, central hole of the needle body (1511), projection in the central hole of the needle body (1512) that leads to the convex internal channel (1513), which has its diameter reduced in the reduced diameter internal channel E (1514), and, externally, external thread (1515) and chamfers on the upper and lower external edges, the second part of the needle body (152) has an octave ring (1521) in its external part, below the external thread (1515), and in its interior, in continuation of the internal channel of reduced diameter E (1514), tapering in the central hole of the needle body (1522), of angle α5 (α5), and central channel of the needle body (1523), the third part of the needle body (153) has a smaller diameter than the second part of the needle body (152), external chamfers in the upper and lower parts, and a recess in the needle body (1531) for insertion of the sealing ring, and the fourth part of the needle body (154) has rounded chamfers E (1541) on its exterior and exit from the central channel of the needle body (1542) on the lower face with chamfers.

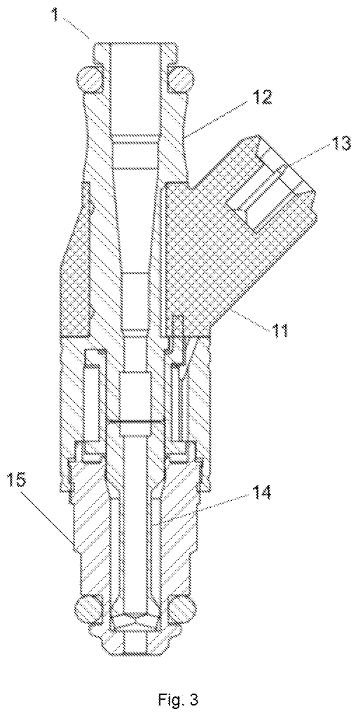

FIG. 3 details the assembly of the high-flow injector (1). The coil and connector assembly (13) is fitted to the internal part of the coil body (12), in the internal space for the coil (1244), and the connector (132) passes through the input channel of the connector (1241) so that it is exposed, being surrounded by the housing (11). The spring (16) is positioned in the reduced diameter internal channel D (1243). The needle body (15) fits into the lower inner part of the coil body (12), in the internal space for the needle body (1246). The needle (14) is positioned inside the central channel of the needle body (1523), with its upper part positioned in the central through hole A (1311) of the coil. This way, the internal channels of the components are aligned, allowing the fuel to flow. When the high flow injector (1) is activated, the coil (131) is energized, moving the needle upwards and compressing the spring (16), then the coil is de-energized and the compressed spring (16) moves the needle (14) again, but in the opposite direction.

### EXAMPLES OF EMBODIMENTS OF THE INVENTION

In one of the embodiments of the invention, the high-flow fuel injector (1), properly assembled, has a length between 70 and 76 mm, preferably 73.5 mm, the distance between the recess in the coil body (1212) and the recess in the body of the needle (1531), is between 58.50 and 62.50 mm, preferably 60.50 mm, the gap between the upper face of the needle (14) and the lower inner face of the coil body (12) is between 0.05 and 0.25 mm, preferably 0.15 mm, and the length of the needle (14) is between 23.40 and 27.00, preferably 25.20 mm. The coil body (12) is made of metallic material, preferably V430FG stainless steel and is manufactured by machining. The first part of the coil body (121) has an initial external diameter between 8 and 12 mm, preferably 10 mm, and the fuel inlet channel (1211) has a diameter between 4 and 8 mm, preferably 6 mm, which reduces to a diameter between 7.30 and 9.30 mm, preferably 7.80 mm, in the recess of the coil body (1212). The convex side surface (1221) has a radius between 16 and 20 mm, preferably 18 mm. The tapering in the internal channel A (1222) has an angulation between 28° and 32°, preferably 30°, and the reduced diameter internal channel A (1223) has a diameter between 5 and 6 mm, preferably 5.50 mm. The third part of the coil body (123) has an external diameter between 9 and 13 mm, preferably 11 mm, the tapering in the internal channel B (1231) has an angulation between 8° and 12°, preferably 10°, the reduced diameter internal channel B (1232) has diameter between 2.80 and 3.80 mm, preferably 3.30 mm, and the tapering in the internal channel C (1233) has an angle between 38° and 42°, preferably 40°. The fourth part of the coil body (124) has an external diameter between 16 and 20 mm, preferably 18 mm, the internal channel reduced diameter C (1242) has a diameter between 2.20 and 3.2 mm, preferably 2.70 mm, the internal channel reduced diameter D (1243) has a diameter between 3.00 and 4.60 mm, preferably 3.80 mm, the distance between the top of the needle fitting space (1245) and the top of the internal space for the needle body (1246) is between 2.00 and 3.20 mm, preferably 2.60 mm, the distance between the lower face of the coil body (12) and the upper part of the internal channel reduced diameter D (1243) is between 13.50 and 15, 50 mm, preferably 14.41 mm, the lower part of the fourth part of the coil body (124), where the needle body (15) is positioned, has an internal diameter between 13.50 and 15.50 mm, preferably 14.50 mm, and the internal thread (1247) is preferably M16×0.50.

The coil (131) has an external diameter, in its upper part, between 10.00 and 14.00 mm, preferably 12.00 mm, and an external diameter, in its lower part, between 10.00 and 14.00 mm, preferably 12.10 mm, the part where the wire is wound has a diameter between 8.00 and 9.40 mm, preferably 8.70 mm, the central hole A (1311) has a diameter between 6.00 and 8.00 mm, preferably 7.00 mm, the central hole B (1313) has a diameter between 6.00 and 8.00 mm, preferably 7.10 mm, and the slot in the coil (1314) has a depth between 0.15 and 0.35 mm, preferably 0.25 mm. The coil wire is preferably AWG 33. The connector (132) is made of metallic material and undergoes surface treatment to optimize its conductivity and impedance, preferably silver plating.

The needle (14) has a solid body, made of metallic material, preferably V430 stainless steel, and is manufactured by machining. The needle (14) has a total length of between 22.00 and 28.00 mm, preferably 25.20 mm, and the distance between the upper face of the needle (14) and the end of the central recessed hole (141) is between 22.00 and 24.40 mm, preferably 23.20 mm. The central hole with recess (141) has a diameter of the recessed part between 3.00 and 4.50 mm, preferably 3.75 mm, the recess has a depth between 1.00 and 2.60 mm, preferably 1.80 mm, and the rest of the hole It has a diameter between 2.00 and 3.60 mm, preferably 2.80 mm. The external diameter of the needle is, in its upper part, between 6.00 and 8.00 mm, preferably 6.98 mm, the central body of the needle (144) has a diameter between 3.00 and 4.60 mm, preferably 3.80 mm. The fuel outlet hole (146) has a diameter between 1.00 and 1.80 mm, preferably 1.40 mm, its inclination angle α3 (α3) is between 12° and 18°, preferably 15°, and its length in relation to the longitudinal axis of the needle is between 2.00 and 3.20 mm, preferably 2.62 mm. The final needle portion, before chamfer D (147), has a diameter between 5.00 and 7.00 mm, preferably 5.93 mm, and between 4.00 and 5.80 mm, preferably 4.90 mm, after chamfer D (147).

The needle body (15) is made of metallic material, preferably V430 stainless steel, and is manufactured by machining. The first part of the needle body (151) has an external diameter between 13.50 and 15.50 mm, preferably 14.46 mm, the external thread (1515) is, preferably, M16×0.50, the central hole of the needle body (1511) has an initial diameter between 11.70 and 13.70 mm, preferably 12.70 mm, the projection in the central hole of the needle body (1512) has a height between 1.50 and 2.30 mm, preferably 1.80 mm, and the diameter after the projection 7.80 and 8.80 mm, preferably 8.30m, the convex internal channel (1513) has a diameter between 7.02 and 7.04 mm and a radius of curvature between 1.50 and 2.50 mm, preferably 2.00 mm, the reduced diameter internal channel E (1514) has a diameter between 6.50 and 8.00 mm, preferably 7.25 mm. The second part of the needle body (152) has an external diameter between 13.80 and 15.80 mm, preferably 14.80 mm, the octave ring (1521) has a diameter between 15.00 and 17.00 mm, preferably 16.00 mm, and its straight part is square with a side between 14.00 and 16.00 mm, preferably 15.00 mm. The taper in the central hole of the needle body (1522) has an angulation α5 (α5) between 25° and 35°, preferably 30°, and the central channel of the needle body (1523) has a diameter between 5.00 and 7.00 mm, preferably 6.00 mm. The needle body recess (1531) has an external diameter between 6.90 and 8.90 mm, preferably 7.90 mm. The outlet of the central channel of the needle body (1542) has a diameter between 2.20 and 3.20 mm, preferably 2.70 mm and a chamfer of 0.20 mm and 45°, which allows fuel to exit at an angle between 15° and 21°, preferably 18th. The rounded chamfers E (1541) have a radius between 0.10 and 0.30 mm, preferably 0.20 mm. The distance between the end of the central channel of the needle body (1523) and the upper face of the needle body (15) measures between 21.00 and 24.50 mm, preferably 22.75 mm.

The spring (16) is a metallic material, preferably 17/7Ph stainless steel, which undergoes surface treatment, preferably ball blasting, and chemical treatments, preferably pickling and passivation, has a free length between 9.00 and 12.00 mm, preferably 10.50 mm, closed length between 5.00 and 6.50 mm, preferably 5.75 mm, number of turns between 10.00 and 15.00, preferably 12.50, internal diameter between 2.10 and 3.10 mm, preferably 2.60 mm, external diameter between 3.00 and 4.00 mm, preferably 3.50 mm, and wire diameter between 0.20 and 0.70 mm, preferably 0.45 mm.

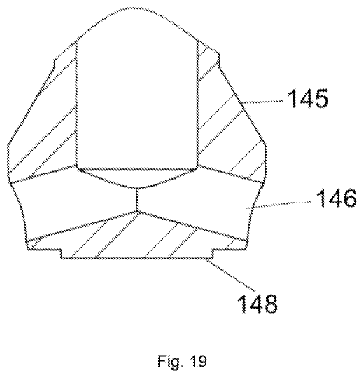

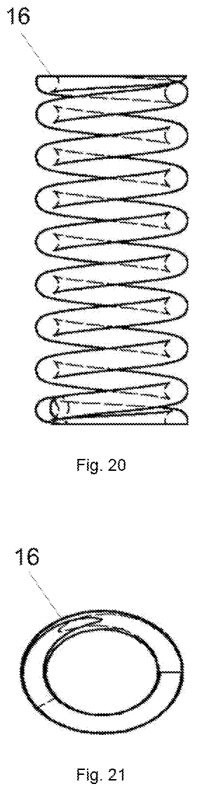

In another embodiment, as detailed in FIG. 19, the lower part of the needle is not flat, there is a centralized projection (148) whose height, measured from the center line of the fuel outlet hole (146), is between 0.80 and 1.10 mm, preferably 0.83 mm.

1. A high flow fuel injector characterized by being equipped with a connector housing (11), in a cylindrical shape, injected in polymeric material and containing a projection that surrounds the connector (132) of the coil body (12), made of metallic material, predominantly cylindrical in shape, with a stepped profile on the outside and with a through channel on the inside, containing four parts, the first part of the coil body (121) being cylindrical and having a fuel inlet channel (1211) on its upper face and its initial outer diameter being reduced, forming the recess of the coil body (1212) with rounded chamfers in the diameter reduction for insertion of the sealing ring, the second part of the coil body (122) is cylindrical, has a convex lateral surface (1221) and an internal channel whose diameter is reduced by the taper in the internal channel A (1222), resulting in the internal channel with reduced diameter A (1223), the third part of the coil body (123), in the shape of an incomplete cylinder, has a flat face on the coil body (1234) in the longitudinal direction, with a chamfer on its upper part, has, in the continuation of the reduced diameter internal channel A (1223), tapering in the internal channel B (1231) inside it, which connects to the reduced diameter internal channel B (1232), which connects to the taper in the internal channel C (1233), and the fourth part of the coil body (124), also cylindrical in shape, has, on its upper face, on the same side as the third part of the coil body (123), a flat face on the coil body (1234), a connector input channel (1241), with an inclination of angle α2 (α2), between 15° and 25°, preferably 20°, inside, it has an internal channel of reduced diameter C (1242), where the spring (16) is positioned, which connects to the internal channel of reduced diameter D (1243), which is connected to the needle fitting gap (1245), it also has an internal gap for coil A (1244), with a chamfer angle α1 (α1), between 0.5° and 2°, preferably 1.5°, internal space for the needle body (1246), and internal thread (1247); equipped with a coil and connector assembly (13), which contains a coil (131) and a connector (132), the coil (131) is cylindrical in shape and has a central hole A (1311), a central hole B (1313), and a projection with the connector passing through (1312), which has a tear in the coil (1314), and the connector (132), made of metallic material, is formed by two rods, each one having a short part of the connector (1321) and a long part of the connector (1322), with an inclination between 35° and 55°, preferably 45°, the coil and connector assembly (13) is fitted into the internal part of the coil body (12), in the internal space for the coil (1244), and the connector (132) passes through the connector input channel (1241) so that it is exposed, being surrounded by the housing (11); equipped with a needle (14) made of metallic material, with a cylindrical shape and stepped profile, which contains a central hole with a recess (141) on its upper face, chamfer A (142) and chamfer B (143), on the upper and lower edges, contains a central body of the needle (144), with a smaller diameter than the initial one, chamfer C (145), with an inclination of angle α4 (α4) and chamfer D (147) on the lower part of the central body of the needle (144), and this has the fuel outlet holes (146), in diametrically opposite positions and with an inclination of angle α3 (α3) in relation to the central axis, the needle (14) is positioned inside the central channel of the needle body (1523); and provided with a needle body (15), made of metallic material, with a cylindrical shape and a stepped profile, which contains, for the purposes of description, four parts, the first part of the needle body (151) has, internally, a central hole in the needle body (1511), a projection in the central hole in the needle body (1512) that leads to the convex internal channel (1513), which has its diameter reduced in the internal channel of reduced diameter E (1514), and, externally, an external thread (1515) and chamfers on the upper and lower external edges, the second part of the needle body (152) has an octagonal ring (1521) on its external part, below the external thread (1515), and on its inside, in the continuation of the internal channel of reduced diameter E (1514), a taper in the central hole in the needle body (1522), with an angle α5 (α5), and a central channel in the needle body (1523), the third part of the needle body (153) has a smaller diameter than the second part of the needle body (152), external chamfers in the upper and lower parts, and a recess in the needle body (1531) for inserting a sealing ring, and the fourth part of the needle body (154) has rounded chamfers E (1541) on its exterior and an exit from the central channel of the needle body (1542) on the lower face with chamfers.

2. The high flow fuel injector, according to claim 1, characterized by, when properly assembled, having a length between 70 and 76 mm, preferably 73.5 mm; the distance between the recess of the coil body (1212) and the recess of the needle body (1531) is between 58.50 and 62.50 mm, preferably 60.50 mm; the gap between the upper face of the needle (14) and the lower internal face of the coil body (12) is between 0.05 and 0.25 mm, preferably 0.15 mm, and the length of the needle (14) is between 23.40 and 27.00, preferably 25.20 mm; the coil body (12) is made of metallic material, preferably V430FG stainless steel, and is manufactured by machining; the first part of the coil body (121) has an initial external diameter between 8 and 12 mm, preferably 10 mm, and the fuel inlet channel (1211) has a diameter between 4 and 8 mm, preferably 6 mm, which reduces to a diameter between 7.30 and 9.30 mm, preferably 7.80 mm, in the recess of the coil body (1212); the convex lateral surface (1221) has a radius between 16 and 20 mm, preferably 18 mm; the taper in the internal channel A (1222) has an angle between 28° and 32°, preferably 30°, and the internal reduced diameter channel A (1223) has a diameter between 5 and 6 mm, preferably 5.50 mm; the third part of the coil body (123) has an external diameter between 9 and 13 mm, preferably 11 mm, the taper in the internal channel B (1231) has an angle between 8° and 12°, preferably 10°, the internal channel reduced diameter B (1232) has a diameter between 2.80 and 3.80 mm, preferably 3.30 mm, and the taper in the internal channel C (1233) has an angle between 38° and 42°, preferably 40°; the fourth part of the coil body (124) has an external diameter between 16 and 20 mm, preferably 18 mm, the internal channel reduced diameter C (1242) has a diameter between 2.20 and 3.2 mm, preferably 2.70 mm, the internal channel reduced diameter D (1243) has a diameter between 3.00 and 4.60 mm, preferably 3.80 mm, the distance between the upper part of the needle fitting gap (1245) and the upper part of the internal space for the needle body (1246) is between 2.00 and 3.20 mm, preferably 2.60 mm, the distance between the lower face of the coil body (12) and the upper part of the internal channel reduced diameter D (1243) is between 13.50 and 15.50 mm, preferably 14.41 mm, the lower part of the fourth part of the body of the coil (124), where the body is positioned of the needle (15), have an internal diameter between 13.50 and 15.50 mm, preferably 14.50 mm, and the internal thread (1247) is preferably M16×0.50.

3. The high flow fuel injector, according to claim 1, characterized in that the coil (131) has an external diameter, in its upper part, between 10.00 and 14.00 mm, preferably 12.00 mm, and an external diameter, in its lower part, between 10.00 and 14.00 mm, preferably 12.10 mm, the part where the wire is wound has a diameter between 8.00 and 9.40 mm, preferably 8.70 mm, the central hole A (1311) has a diameter between 6.00 and 8.00 mm, preferably 7.00 mm, the central hole B (1313) has a diameter between 6.00 and 8.00 mm, preferably 7.10 mm, and the slit in the coil (1314) has a depth between 0.15 and 0.35 mm, preferably 0.25 mm; the coil wire is preferably AWG 33; the connector (132) is made of metallic material and undergoes surface treatment to optimize its conductivity and impedance, preferably silver plating.

4. The high flow fuel injector, according to claim 1, characterized in that the needle (14) has a solid body, made of metallic material, preferably V430 stainless steel, and is manufactured by machining; the needle (14) has a total length between 22.00 and 28.00 mm, preferably 25.20 mm, and the distance between the upper face of the needle (14) and the end of the central hole with recess (141) is between 22.00 and 24.40 mm, preferably 23.20 mm; the central hole with recess (141) has a diameter of the recessed part between 3.00 and 4.50 mm, preferably 3.75 mm, the recess has a depth between 1.00 and 2.60 mm, preferably 1.80 mm, and the remainder of the hole has a diameter between 2.00 and 3.60 mm, preferably 2.80 mm; the external diameter of the needle has, in its upper part, between 6.00 and 8.00 mm, preferably 6.98 mm, the central body of the needle (144) has a diameter between 3.00 and 4.60 mm, preferably 3.80 mm; the fuel outlet hole (146) has a diameter between 1.00 and 1.80 mm, preferably 1.40 mm, its angle inclination α3 (α3) is between 12° and 18°, preferably 15°, and its length in relation to the longitudinal axis of the needle is between 2.00 and 3.20 mm, preferably 2.62 mm; the end portion of the needle, before the chamfer D (147), has a diameter between 5.00 and 7.00 mm, preferably 5.93 mm, and between 4.00 and 5.80 mm, preferably 4.90 mm, after the chamfer D (147).

5. The high flow fuel injector, according to claim 1, characterized in that the body of the needle (15) is made of metallic material, preferably V430 stainless steel, and is manufactured by machining; the first part of the needle body (151) has an external diameter between 13.50 and 15.50 mm, preferably 14.46 mm, the external thread (1515) is preferably M16×0.50, the central hole of the needle body (1511) has an initial diameter between 11.70 and 13.70 mm, preferably 12.70 mm, the projection in the central hole of the needle body (1512) has a height between 1.50 and 2.30 mm, preferably 1.80 mm, and the diameter after the projection is 7.80 and 8.80 mm, preferably 8.30m, the convex internal channel (1513) has a diameter between 7.02 and 7.04 mm and a radius of curvature between 1.50 and 2.50 mm, preferably 2.00 mm, the internal channel reduced diameter E (1514) have a diameter between 6.50 and 8.00 mm, preferably 7.25 mm; the second part of the needle body (152) has an external diameter between 13.80 and 15.80 mm, preferably 14.80 mm, the octagonal ring (1521) has a diameter between 15.00 and 17.00 mm, preferably 16.00 mm, and its straight part being square on the side between 14.00 and 16.00 mm, preferably 15.00 mm; the taper in the central hole of the needle body (1522) has an angle α5 (α5) between 25° and 35°, preferably 30°, and the central channel of the needle body (1523) has a diameter between 5.00 and 7.00 mm, preferably 6.00 mm; the recess of the needle body (1531) has an external diameter between 6.90 and 8.90 mm, preferably 7.90 mm; the outlet of the central channel of the needle body (1542) has a diameter between 2.20 and 3.20 mm, preferably 2.70 mm and a chamfer of 0.20 mm and 45°, which allows the fuel to exit at an angle between 15° and 21°, preferably 18°; the rounded chamfers E (1541) has a radius between 0.10 and 0.30 mm, preferably 0.20 mm; the distance between the end of the central channel of the needle body (1523) and the upper face of the needle body (15) measures between 21.00 and 24.50 mm, preferably 22.75 mm.

6. The high flow fuel injector, according to claim 1, characterized in that the spring (16) is made of metallic material, preferably 17/7Ph stainless steel, and undergoes surface treatment, preferably blasting with spheres, and chemical treatments, preferably pickling and passivation, has a free length between 9.00 and 12.00 mm, preferably 10.50 mm, closed length between 5.00 and 6.50 mm, preferably 5.75 mm, number of turns between 10.00 and 15.00, preferably 12.50, internal diameter between 2.10 and 3.10 mm, preferably 2.60 mm, external diameter between 3.00 and 4.00 mm, preferably 3.50 mm, and wire diameter between 0.20 and 0.70 mm, preferably 0.45 mm.

7. The high flow fuel injector, according to claim 1, characterized in that the lower face of the needle (14) has a centralized projection (148) and its height, measured from the central line of the fuel outlet hole (146), is between 0.80 and 1.10 mm, preferably 0.83 mm.
